(19) United States
(12) Patent Application Publication
(10) Pub. No.: US 2002/0127923 A1
(43) Pub. Date: Sep. 12, 2002

(54) Reverse-wound electrical connector

(76) Inventor: Roy K. Warner, Lehigh Acres, FL (US)

Correspondence Address: Andrew D. Stover, Brinks Hofer Gilson & Lione, P.O. Box 10395, Chicago, IL, 60610, US

(21) Appl. No.: 10/091,715

(22) Filed: Mar. 6, 2002

Related U.S. Application Data
(60) Provisional application No. 60/274,483, filed on Mar. 8, 2001.

(51) Int. Cl. H01R 4/40

(52) U.S. Cl. 439/789

(57) ABSTRACT

An electrical connector includes a first part having a tail and a generally cylindrical head that is divided into segments. The connector also includes second and third parts, each having a tail and a head, wherein the heads of the second and third parts are wrapped in the reverse direction from the head of the first part, and wherein the head of the second and third parts receive the head of the first part for rotation. A split, internally-threaded bushing is positioned inside the segment of the first part aligned with the second part, and this segment is engaged with the second head such that rotation of the second part to a closed position compresses the threaded split bushing. The heads of the third parts and the associated segments of the first part are provided with cable-receiving openings that are misaligned to a greater extent when the third parts are in a closed position as compared to an open position.

### BACKGROUND

The present invention relates to electrical connectors of the type used to terminate a cable or a stud.

Warner U.S. Pat. No. 5,919,065 discloses an electrical connector having inner and outer conductive straps that are wrapped in reverse directions with respect to an axis of rotation of the connector. Though the illustrated connector is capable of making electrical connection with two cables or a cable and a ground rod, both must be installed and connected at the same time, because the connector includes only two connector parts that rotate relative to one another.

U.S. patent application Ser. No. 09/574,049, filed May 18, 2000, assigned to the assignee of the present invention, and hereby incorporated by reference, discloses an electrical connector that uses extruded parts to terminate a plurality of generally parallel cables as well as a threaded stud. In the disclosed connector, the threaded stud is oriented perpendicularly to the terminated cables. The disclosed connector has been found to function reliably in use, but it would be advantageous to reduce the weight and cost of the connector.

### SUMMARY

By way of general introduction, the electrical connector described below includes first, second and third connector parts. The first connector part is wound in a counterclockwise direction, and it includes a first head portion and a first tail portion. The first head is divided into a number of axially spaced segments by respective gaps.

The second connector part includes a second tail portion as well as a second head portion that receives one of the segments of the first connector part. The second head portion is wound in the clockwise direction, and the first and second head portions are mechanically engaged with one another, in this example by a plug extending through aligned openings. When the second connector part is rotated to a closed position, this plug exerts forces on the first head portion tending to reduce the diameter of the first head portion by wrapping it more tightly about the axis of rotation. An internally-threaded split bushing is inserted within the first head portion. By rotating the second connector part to the closed position, this split bushing is compressed against a threaded stud, thereby securing the electrical connector to the threaded stud.

Each of the third connector parts is shaped generally similarly to the second connector part, except the third connector parts and the associated segments of the first connector part are provided with conductor-receiving openings that are misaligned to a greater extent when the third connector parts are rotated to respective closed positions. The third connector parts cooperate with the respective segments to terminate respective conductors, e.g., large-diameter cables, to the electrical connector.

The foregoing section has been provided by way of general introduction, and it should not be used to narrow the scope of the following claims.

### BRIEF DESCRIPTION OF THE DRAWINGS

FIG. 1 is a perspective view of an electrical connector that incorporates a preferred embodiment of this invention.

FIG. 2 is a top view in partial cutaway of the electrical connector of FIG. 1.

FIG. 3 is a cross-sectional view taken along line 3-3 of FIG. 2 showing the illustrated connector parts in a closed position.

FIG. 4 is a cross-sectional view taken in the plane of FIG. 3, showing the illustrated connector parts in an open position.

FIG. 5 is a cross-sectional view taken along line 5-5 of FIG. 2, showing the illustrated connector parts in a closed position.

FIG. 6 is a cross-sectional view in the plane of FIG. 5, showing the illustrated connector parts in an open position.

### DETAILED DESCRIPTION OF THE PRESENTLY PREFERRED EMBODIMENTS

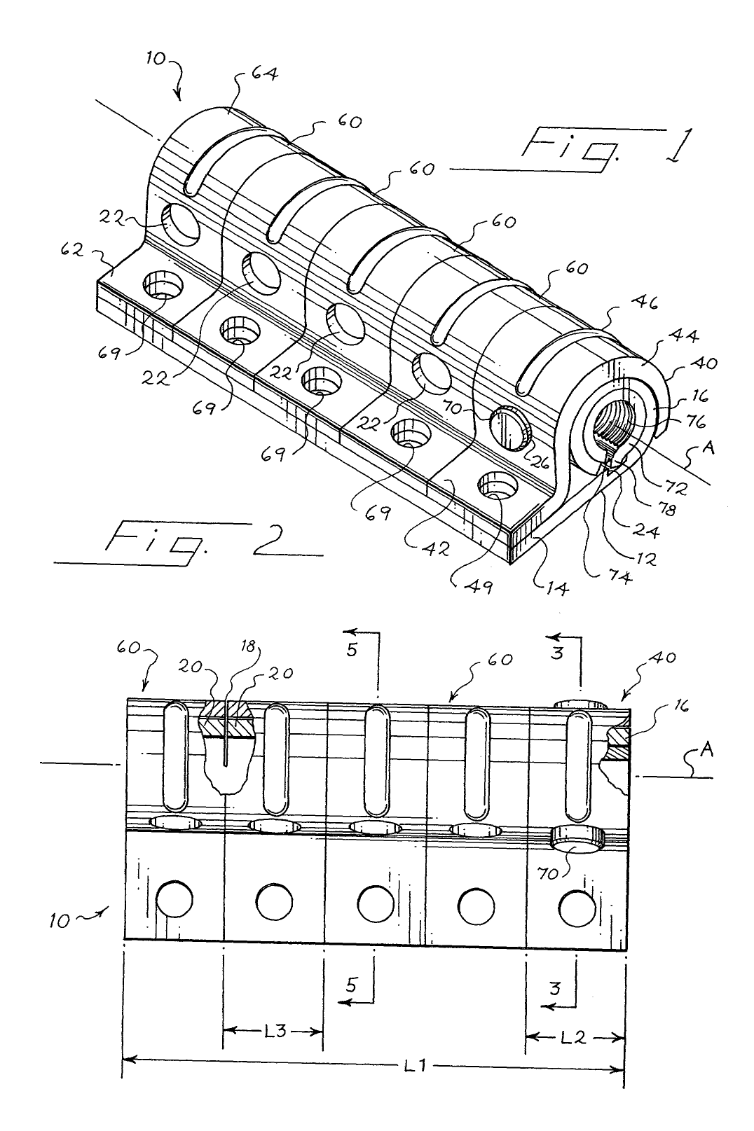

Turning now to the drawings, FIG. 1 shows an overall view of an electrical connector 10 that incorporates a preferred embodiment of this invention. The connector 10 includes a first connector part 12, a second connector part 40, and multiple third connector parts 60.

The first connector part 12 includes a first tail portion 14 and a first head portion 16. In this example, the first head portion 16 is partially cylindrical about an axis A, and it is wrapped about the axis A in a counterclockwise direction in the view of FIG. 1. The first head portion 16 is segmented by a plurality of parallel gaps 18, that may for example be formed as saw kerfs (FIG. 2). The gaps 18 divide the first head portion 16 into a plurality of axially spaced segments 20. The gaps 18 extend from the free end of the first head portion 16 farthest from the first tail portion 14 to the dotted line 19 shown in FIG. 3. A slot 24 extends parallel to the axis A in one of the end segments 20.

The right hand segment 20 in the view of FIG. 1 includes a hole 26, and each of the remaining segments 20 includes a pair of conductor-receiving openings 22. The first tail portion 14 is provided with a plurality of fastener openings 28, each aligned with a respective one of the openings 26, 22.

The second connector part 40 includes a second tail portion 42 and second head portion 44. In this embodiment, the second head portion 44 is shaped as a part of a cylinder, and the second head portion 44 is wrapped in the clockwise direction about the axis A in the view of FIG. 1. Each second tail 42 defines a respective fastener opening 49 positioned to align with the respective fastener opening 28. As shown in FIGS. 1, 3 and 4, the second head portion 44 receives the first head portion 16 for rotation about the axis A. The second head portion 44 is strengthened by a circumferentially-extending ridge 46, and the head portion 44 defines a hole 48 sized to align with the hole 28 when the second connector part 44 is positioned relative to the first connector part 12 as shown in FIG. 4.

As best shown in FIGS. 1, 5 and 6, each third connector part 60 includes a respective third tail portion 62 and a respective third head portion 64. In general, each of the third connector parts 60 is shaped quite similarly to the second connector part 40, including a similar circumferentially-extending ridge 66. The main difference is that each of the third connector parts 60 includes a pair of conductor-receiving openings 68 positioned to align with the corresponding conductor-receiving openings 22 when the respective connector part 60 is positioned in the open position shown in FIG. 6. Each third tail portion 62 defines a respective fastener opener 69 positioned to align with the corresponding fastener opening 28.

As best shown in FIGS. 1, 3 and 4, the connector 10 also includes a plug 70 that mechanically interconnects one segment of the first head portion 16 with the second head portion 44. The plug 70 can for example be a solid metallic element that pins the respective portions of the first and second connector parts together without any substantial play therebetween. In this example, a second plug 71 is positioned opposite the plug 70, and the second plug 71 also mechanically interconnects the head portions 16, 44. The plugs 70, 71 can be press fit in place. Other structures can be used, such as abutting shoulders on the elements 16, 44.

Also as shown in FIGS. 1, 3 and 4, the electrical connector 10 includes a split bushing 72. The bushing 72 defines a gap 74 between opposed free ends, and it includes internal threads 76. One of the free ends of the bushing 72 is turned radially outwardly to form a protrusion 78, and in this example the opposite part of the bushing 72 mechanically engages a protruding pin on the plug 70.

As best shown in FIG. 2, the electrical connector 10 and the first part 12 define an overall length L1 measured parallel to the axis A. The second connector part 40 defines an axial length L2 along the axis A, and each of the third connector part 60 defines an axial length L3 along the axis A. In general, L1 is substantially greater (about 2 times or more) than the length L2. In this example, L2 is equal to L3, and the length of each of the segments 20 is substantially equal to L2. In the example of FIG. 2, L1 equals five times L2 or L3.

By way of example, the connector parts 12, 40 and 60 can be formed of respective aluminum straps that are cold formed and machined to form the illustrated shapes. For example, an aluminum alloy such as 6061-T6 can be used. Any suitable conductive metal can be used for the bushing 72, such as aluminum, copper or brass. The plugs 70, 71 can be made of a similar aluminum alloy as that used to form the connector parts 12, 40, 60.

In operation, the second connector part 40 cooperates with the associated segment 20 and the bushing 72 to connect the electrical connector 10 electrically and physically to a threaded stud (not shown). FIG. 4 shows the second connector part 40 in an open position, in which the internal diameter of the bushing 72 (measured transversely to the axis A) is a relatively larger value. Once the threaded stud and the bushing 72 have been assembled with the stud in the bushing 72, the second tail portion 42 is rotated into position against the first tail portion 14 via a suitable fastener extending through the fastener openings 28,49. This rotation of the second connector part 40 relative to the first connector part 12 winds the second head portion 44 more tightly around the axis A, thereby compressing the split bushing 72 and reducing its internal diameter. This causes the threaded bushing 72 to clamp securely against the threaded stud.

In one mode of operation, the threaded stud is first threaded into the bushing 72 while the bushing is separated from the electrical connector 10. Then the second connector part 40 is positioned as shown in FIG. 4, and the bushing 72 is moved into position by sliding the protrusion 78 along the slot 24. Once the bushing 72 is completely inserted, the second connector part 40 is then clamped in the closed position of FIG. 3.

Alternatively, in some embodiments the split bushing 72 can open sufficiently in the position of FIG. 4 to allow the threaded stud S to be inserted into the bushing 72 without relative rotation therebetween.

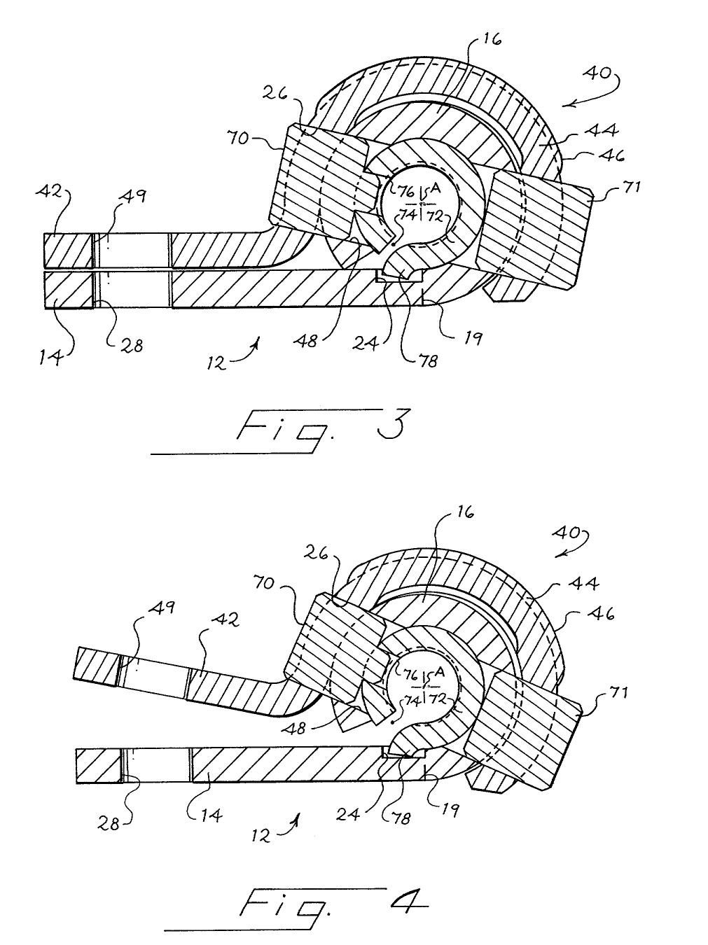

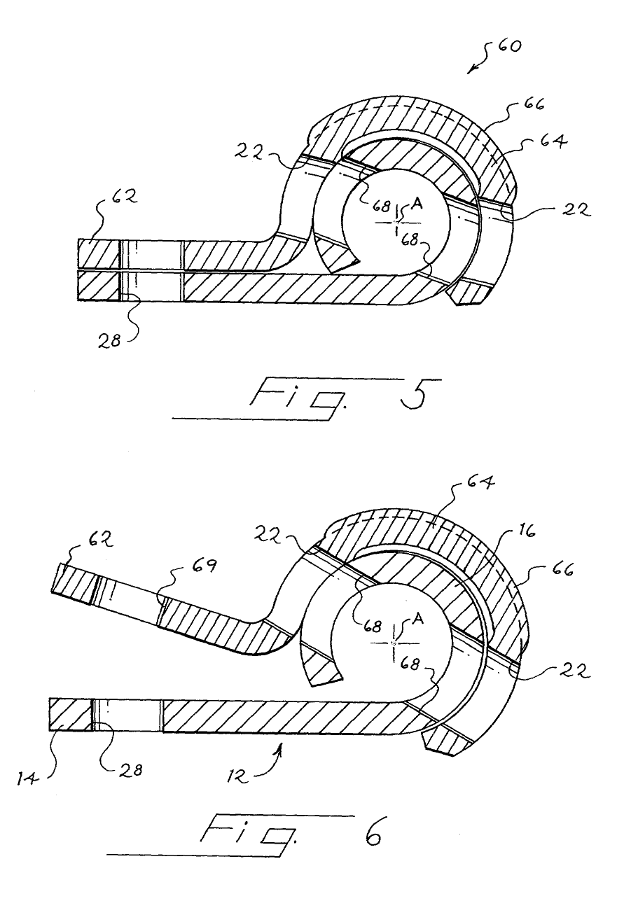

FIGS. 5 and 6 show the manner in which the third connector parts 60 are used to terminate respective cables. First, the respective third connector part 60 is moved to the opened position of FIG. 6, in which the conductor-receiving openings 68 are aligned with the conductor-receiving openings 22. An electrical cable (not shown) is then inserted through the openings 22, 68, and then a fastener passing through the openings 28, 69 is used to rotate the third tail portion 62 against the first tail portion 14 as shown in FIG. 5. This rotation causes progressively more misalignment between the openings 22, 68, thereby securely clamping and electrically connecting the cable to the connector 10.

In this example, the first tail portion 14 is uninterrupted and forms a single, integrated plate under the second tail portion 42 and all of the third tail portions 62. However, the gaps 18 ensure that the segments 20 of the first head portion 16 each provide an individual spring action when clamped against the respective cable.

Of course, many changes and modifications can be made to the preferred embodiment described above. For example, the protrusion 78 may be separately formed and attached by any suitable means either to the bushing 72 or to the first head portion 16. Thus, the protrusion 78 may be formed on the bushing 72 or alternately on the first connector part 12.

As another example, the connector can be reconfigured such that it is the outermost head portion that forms the elongated element having a tail portion 14 that extends over the full length of the connector. In this case, it is the radially inner head portions that are formed as separate elements.

Also, various features of the electrical connector 10 can be used separately rather in the preferred combination described above. For example, the second connector part 40 and the bushing 72 described above can be used whether or not multiple third connector parts are provided. Similarly, the multiple third connector parts described above can be used whether or not a second connector part is used.

As used herein the term “wrap” is intended broadly to include wrapping over a part of a circumference.

The term “mechanically engaged” is intended broadly to encompass a wide range of mechanical engagements, whether formed by a separate element such as a plug, pin or bolt, or by a protruding portion of one of the two engaged elements.

The term “substantially longer” is intended to mean longer by a factor of about two times or more and the term “set” means one or more.

The term “gap” is intended broadly to encompass the space between adjacent or abutting surfaces, as long as the adjacent surfaces (whether abutting or not) are capable of relative movement therebetween.

The foregoing detailed description has discussed only a few of the many forms that this invention can take. This detailed description is therefore intended by way of illustration and not limitation. It is only the following claims, including all equivalents, that are intended to define the scope of this invention.

1. An electrical connector comprising:
a first connector part comprising a first head portion and a first tail portion, said first head portion wrapped around an axis in a first direction;
a second connector part comprising a second head portion and a second tail portion, said second head portion wrapped around the axis in a second direction, opposite the first direction;
said second head portion receiving the first head portion for relative rotation therebetween about the axis;
said first head portion mechanically engaged with the second head portion such that rotation of the second connector part to move the second tail toward the first tail wraps the first head portion farther around the axis in the first direction, thereby reducing an internal dimension of the fist head portion along a line transverse to the axis.

2. An electrical connector comprising:
a first connector part comprising a first head portion and a first tail portion, said first head portion wrapped around an axis in a first direction;
a set of additional connector parts, each additional connector part comprising a respective additional head portion and a respective additional tail portion, each additional head portion wrapped around the axis in a direction opposite the direction in which said first connector part is wrapped;
wherein the first connector part is substantially longer than each additional connector part, measured along the axis;
wherein the head portion of one of the first and each additional connector part is received within the head portion of the other;
wherein the head portions of the first and each additional connector part have a set of conductor-receiving openings, said conductor-receiving openings misaligned to a variable extent depending on a rotational position of each additional connector part relative to the first connector part.

3. An electrical connector comprising:
a first connector part comprising a first head portion and a first tail portion, said first head portion wrapped around an axis in a first direction, said first head portion divided into a plurality of segments axially spaced along the axis, said first tail portion extending across all of the segments;
a second connector part comprising a second head portion and a second tail portion, said second head portion wrapped around the axis in a second direction, opposite the first direction;
a set of third connector parts, each third connector part comprising a respective third head portion and a respective third tail portion, each third head portion wrapped around the axis in the second direction;
said second and third head portions each mounted over the respective segment of the first head portion to pivot about the axis;
said second head portion mechanically engaged with the respective segment of the first head portion such that rotation of the second connector part to move the second tail toward the first tail wraps the respective segment of the first head portion farther around the axis in the first direction, thereby reducing an internal dimension of the respective segment along a line transverse to the axis.

4. The invention of claim 1 or 3 further comprising:
a bushing disposed in the second head portion.

5. The invention of claim 4 wherein the bushing is internally-threaded.

6. The invention of claim 4 wherein the bushing comprises a split bushing.

7. The invention of claim 6 wherein the split bushing is mechanically engaged with the first head portion to resist rotation therebetween about the axis.

8. The invention of claim 5 wherein one of the bushing and the first head portion comprises a slot, wherein the other of the bushing and the first head portion comprises a protrusion, and wherein the slot is configured to receive the protrusion such that the bushing can be moved into and out of the first head portion by sliding the protrusion along the slot.

9. The invention of claim 1 wherein one of the first and second connector parts is substantially longer than the other connector parts measured along the axis.

10. The invention of claim 9 further comprising a set of third connector parts, each third connector part comprising a respective third head portion and a respective third tail portion, each third head portion wrapped around the axis in a direction opposite the direction in which said longer connector part is wrapped;
wherein the head portion of one of the longer and each third connector part is received within the head portion of the other.

11. The invention of claim 10 wherein
the head portions of the longer and each third connector part have a set of conductor-receiving openings, said conductor-receiving openings misaligned to a variable extent depending on a rotational position of each third connector part relative to the longer connector part.

12. The invention of claim 2 wherein the head portion of each additional connector part comprises a circumferentially-extending ridge.

13. The invention of claim 3 wherein the head portion of the second connector part comprises a circumferentially-extending ridge.

14. The invention of claim 13 wherein the head portion of each third connector part comprises a circumferentially-extending ridge.

15. The invention of claim 2 wherein the first head portion is divided into a row of segments by a set of gaps spaced along the axis, and wherein the tail portion of the first connector part bridges said segments.

16. The invention of claim 15 wherein the gaps extend completely through the first head portion to the first tail portion.

17. The invention of claim 15 wherein the first connector part is integrally formed from a single metal strap that comprises the first tail portion and the segments of the first head portion.

18. The invention of claims 1 or 2 or 3 wherein the connector parts each comprises a respective metal plate.

19. The invention of claim 15 wherein the segments of the first connector part, and each additional connector part each comprise a respective metal strap.

20. The invention of claim 3 wherein a plurality of the segments of the first head portion and the respective third head portions have a set of conductor-receiving openings, said conductor-receiving openings misaligned to a variable extent depending on a rotational position of each third connector part relative to the respective segments of the first connector part.
